(19) United States
(12) Patent Application Publication
(10) Pub. No.: US 2026/0187718 A1
(43) Pub. Date: Jul. 2, 2026

(54) COMPUTER-IMPLEMENTED METHODS, SYSTEMS COMPRISING COMPUTER-READABLE MEDIA, AND ELECTRONIC DEVICES FOR DETERMINATION OF CREDIT RISK

(71) Applicant: Mastercard International Incorporated, Purchase, NY (US)

(72) Inventor: Saeed Mirshekari, O'Fallon, MO (US)

(73) Assignee: Mastercard International Incorporated, Purchase, NY (US)

(21) Appl. No.: 19/427,157

(22) Filed: Dec. 19, 2025

Related U.S. Application Data
(60) Provisional application No. 63/739,375, filed on Dec. 27, 2024.

(51) Int. Cl. G06Q 40/03

(52) U.S. Cl. CPC G06Q 40/03

(57) ABSTRACT

A computer-implemented method for determination of credit risk that includes: retrieving first account data of a plurality of credit accountholders, the first account data originating at or prior to a first time; analyzing second account data of the credit accountholders to determine a delinquency label for each of the credit accountholders at a second time, the second account data originating at or prior to the second time and the second time being after the first time; generating model training data based on the first account data, the second account data and the plurality of delinquency labels corresponding to the credit accountholders; training a machine learning model to predict future delinquency status using supervised learning with the model training data as input; and deploying the trained machine learning model for use in a production environment by a financial institution in predicting the future delinquency status of one or more credit accounts.

### RELATED APPLICATIONS

The current patent application claims the benefit under 35 U.S.C. § 119(e) of the priority date of U.S. Provisional Application Ser. No. 63/739,375 titled “COMPUTER-IMPLEMENTED METHODS, SYSTEMS COMPRISING COMPUTER-READABLE MEDIA, AND ELECTRONIC DEVICES FOR DETERMINATION OF CREDIT RISK” and filed Dec. 27, 2024. The Provisional Application is hereby incorporated by reference, in its entirety, into the current patent application.

### FIELD OF THE INVENTION

The present disclosure generally relates to computer-implemented methods, systems comprising computer-readable media, and electronic devices for determination of credit risk and, more particularly, to training and/or operation of machine learning models for making such determinations.

### BACKGROUND

Manual data labeling used in training machine learning models—e.g., via supervised training—requires huge expenditures of time. However, attempts to replace manual labeling have consistently resulted in sacrifices of accuracy and usefulness of the labeled data. Moreover, AI models supporting annotation and labeling efforts often carry high computational resource demands, in addition to accuracy problems, and therefore represent their own limitations.

Accordingly, significant and persistent involvement by human labelers is, under existing technology paradigms, indispensable for labeling financial data, despite being prohibitively resource intensive.

This background discussion is intended to provide information related to the present invention which is not necessarily prior art.

### BRIEF SUMMARY

Embodiments of the present technology relate to computer-implemented methods, systems comprising computer-readable media, and electronic devices for deploying a machine learning model trained using supervised training on automatically labeled credit accountholder data. The embodiments provide a technological mechanism for evolved reduction in manual labeling burdens in connection with financial data annotation. Namely, embodiments of the present invention include iterative model training data generation through automated labeling and/or generation of velocity features enabling such burden reductions. In preferred embodiments, automated labeling based on velocity feature generation according to the method described in more detail herein specifically embodies a new method for training models which is vastly more efficient. Resultant models may be scalable, efficient, and quick to train and deploy.

More particularly, in an aspect, a computer-implemented method for determination of credit risk includes: retrieving first account data of a plurality of credit accountholders, the first account data originating at or prior to a first time; analyzing second account data of the credit accountholders to determine a delinquency label for each of the credit accountholders at a second time, the second account data originating at or prior to the second time and the second time being after the first time; generating model training data based on the first account data, the second account data and the plurality of delinquency labels corresponding to the credit accountholders; training a machine learning model to predict future delinquency status using supervised learning with the model training data as input; and deploying the trained machine learning model for use in a production environment by a financial institution in predicting the future delinquency status of one or more credit accounts. The method may include additional, less, or alternate actions, including those discussed elsewhere herein.

In another aspect, non-transitory computer-readable storage media having computer-executable instructions stored thereon for credit risk determination may be provided. When executed by at least one processor the computer-executable instructions cause the at least one processor to: retrieve first account data of a plurality of credit accountholders, the first account data originating at or prior to a first time; analyze second account data of the credit accountholders to determine a delinquency label for each of the credit accountholders at a second time, the second account data originating at or prior to the second time and the second time being after the first time; generate model training data based on the first account data, the second account data and the plurality of delinquency labels corresponding to the credit accountholders; train a machine learning model to predict future delinquency status using supervised learning with the model training data as input; and deploy the trained machine learning model for use in a production environment by a financial institution in predicting the future delinquency status of one or more credit accounts. The instructions, when executed, may cause the at least one processor to perform additional, less, or alternate actions, including those discussed elsewhere herein.

Advantages of these and other embodiments will become more apparent to those skilled in the art from the following description of the exemplary embodiments which have been shown and described by way of illustration. As will be realized, the present embodiments described herein may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below illustrate various aspects of systems and methods disclosed therein. It should be understood that each Figure illustrates an embodiment of a particular aspect of the disclosed systems and methods, and that each of the Figures is intended to accord with a possible embodiment thereof. Further, wherever possible, the following description refers to the reference numerals included in the following Figures, in which features illustrated in multiple Figures are designated with consistent reference numerals.

FIG. 1 illustrates various components, in block schematic form, of an exemplary system for credit risk determination in accordance with embodiments of the present invention;

FIGS. 2, 3 and 4 illustrate various components of exemplary computing devices shown in block schematic form that may be used with the system of FIG. 1;

FIG. 5 illustrates at least a portion of the steps of an exemplary computer-implemented method for enabling credit risk determination through velocity feature generation, in accordance with embodiments of the present invention;

FIG. 6 illustrates at least a portion of the steps of an exemplary computer-implemented method for enabling credit risk determination through automated labeling of supervised model training data, in accordance with embodiments of the present invention;

FIG. 7 illustrates delineating usable training and testing data along a time scale; and

FIG. 8 illustrates delineating training data from blind set data with reference to time, and delineating the training data from validation set data with reference to accountholder identifications.

The Figures illustrate exemplary embodiments for purposes of illustration only. One skilled in the art will readily recognize from the following discussion that alternative embodiments of the systems and methods illustrated herein may be employed without departing from the principles of the invention described herein.

### DETAILED DESCRIPTION

Existing methods for labeling financial data for training of machine learning models are heavily manual or, where AI tools are used for annotation, sacrifice accuracy and/or carry high computational resource burdens.

According to embodiments of the present technology, computer-implemented methods, systems comprising computer-readable media, and electronic devices are provided for deploying a machine learning model trained using supervised training on automatically labeled credit accountholder data. The embodiments provide a technological mechanism for evolved reduction in manual labeling burdens in connection with financial data annotation. Namely, embodiments of the present invention include iterative model training data generation through automated labeling and/or generation of velocity features enabling such burden reductions.

### Exemplary System

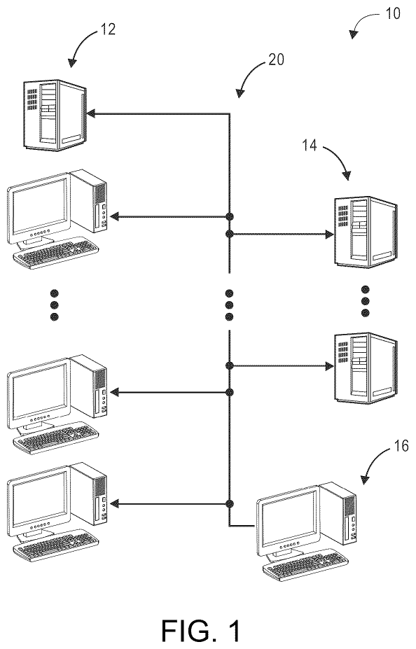

FIG. 1 illustrates an exemplary environment 10 for automatically labeling financial data through and/or including one or more velocity features for or of the financial data, and for training and deploying a machine learning model for determining credit risk, according to embodiments of the present invention. The environment 10 may include a plurality of administrative devices 12, a plurality of servers 14, a service device 16, and a communication network 20. Administrative devices 12, servers 14 and the service device 16 may be located within network boundaries of an organization, such as a corporation or the like that provides financial services. One or more administrative devices 12 and servers 14 may also be outside the network boundaries of the organization.

The communication network 20 may be partly or even mostly internal to the organization, for example where the servers 14 manage databases of and/or provide cloud-based services to and under the management of the organization, and an administrative device 12 is also under the management of the organization. Also or alternatively, the administrative devices 12, servers 14 and service device 16 may access each other via transmissions, at least in part, across public/semi-public telecommunication network infrastructure, with the communication network 20 being at least in part comprised of such public/semi-public telecommunication network infrastructure.

All or some of the administrative devices 12, servers 14, service device 16 and/or all or some of the virtual resources managed thereby, may at least partly comprise a secure network computing environment. Alternatively or in addition, the service device 16 may manage access and transmissions between and among itself and the administrative devices 12 and servers 14 under an authentication management framework. For example, each user of an administrative device 12 may be required to complete an authentication process to access secure data provided via the servers 14 and/or the services provided by and/or to service device 16. In one or more embodiments, any authentication management framework may be utilized including, without limitation, custom frameworks.

For example, the service device 16 may host, aggregate and analyze data and host and provide access to/use of applications comprising financial services. In one or more embodiments, the financial services comprise data aggregation, analysis, management and provision of trained machine learning models to financial institutions who may use such models to automatically determine credit risks associated with credit accountholders or potential accountholders.

The service device 16 also or alternatively manages financial data annotation and/or labeling operations, enabling supervised training of machine learning models for use by the organization and/or the financial institutions, according to embodiments of the present invention.

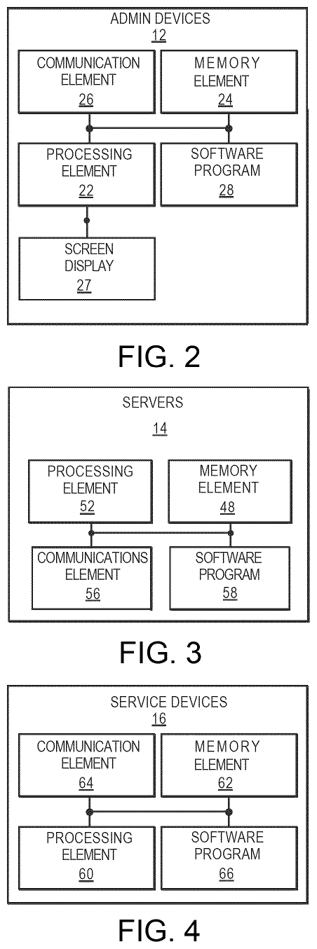

Turning to FIGS. 2 and 4, generally the administrative devices 12 and the service device 16 may include tablet computers, laptop computers, desktop computers, workstation computers, smart phones, smart watches, and the like. In one or more embodiments, the administrative devices 12 and/or the service device 16 may comprise server(s), examples of which are discussed in more detail below. For example, in one or more embodiments the service device 16 directs data retrieval, velocity feature generation, model training and/or deployment operations conducted completely or partly by one or more server(s) 14.

Administrative devices 12 and service device(s) 16 may each respectively include a processing element 22, 60, a memory element 24, 62, and circuitry capable of wired and/or wireless communication with the communication network 20, including, for example, a transceiver or communication element 26, 64. Each of the administrative devices 12 (and service device(s) 16, though not shown in FIG. 4) may additionally include a screen display 27, which may comprise a user interface. The display 27 may include video devices of any of the following types: plasma, standard or ultra-high-definition light-emitting diode (LED), organic LED (OLED), quantum dot LED (QLED), Light Emitting Polymer (LEP) or Polymer LED (PLED), liquid crystal display (LCD), thin film transistor (TFT) LCD, LED side-lit or back-lit LCD, or the like, or combinations thereof. The display 27 may possess a square or a rectangular aspect ratio and may be viewed in either a landscape or a portrait mode. In various embodiments, the display 27 may also include a touch screen occupying all or part of the screen.

Further, each of the administrative devices 12 and the service device 16 may include a software application or program 28, 66 configured with instructions for performing and/or enabling performance of at least some of the steps set forth herein. In an embodiment, the software programs 28, 66 each comprises instructions respectively stored on computer-readable media of a memory element 24, 62.

The servers 14 generally receive requests for financial data sharing and/or machine learning model training and/or model deployment/implementation directly or indirectly from the service device 16, may optionally manage a consent process for obtaining consent for such sharing from data subjects, and may expose or otherwise provide such financial data to or at the request of the service device 16 for training and data labeling/annotation operations. In one or more embodiments, the service device 16 enrolls all or some of the administrative devices 12 and servers 14 and/or the resources embodied thereby for participation in the training and data labeling/annotation operations. Further, in one or more embodiments, the servers 14 host machine learning models trained for credit risk determination according to embodiments of the present invention, which may comprise one or more of large language model(s) (LLMs), logistic regression, decision tree(s), random forest(s), support vector machine(s), XGBoost, Keras Neural Networks, or the like, without limitation.

The servers 14 may comprise cloud servers, domain controllers, application servers, database servers, database web servers, file servers, mail servers, catalog servers or the like, or combinations thereof. In one or more embodiments, one or more data sources for financial account data and transaction records may be maintained by one or more of the servers 14. Generally, each server 14 may include a memory element 48, a processing element 52, a communication element 56, and a software program 58.

The communication network 20 generally allows communication between the administrative devices 12, the servers 14, and the service device 16, for example in conjunction with device enrollment, data acquisition, data consenting, velocity feature generation, data labeling, model training, and model evaluation and deployment operations managed by the service device 16.

The communication network 20 may include the Internet, cellular communication networks, local area networks, metro area networks, wide area networks, cloud networks, plain old telephone service (POTS) networks, and the like, or combinations thereof. The communication network 20 may be wired, wireless, or combinations thereof and may include components such as modems, gateways, switches, routers, hubs, access points, repeaters, towers, and the like. The administrative devices 12, servers 14 and/or services device(s) 16 may, for example, connect to the communication network 20 either through wires, such as electrical cables or fiber optic cables, or wirelessly, such as RF communication using wireless standards such as cellular 2G, 3G, 4G or 5G, Institute of Electrical and Electronics Engineers (IEEE) 802.11 standards such as WiFi, IEEE 802.16 standards such as WiMAX, Bluetooth™, or combinations thereof.

The communication elements 26, 56, 64 generally allow communication between the administrative devices 12, the servers 14, the service device 16 and/or the communication network 20. The communication elements 26, 56, 64 may include signal or data transmitting and receiving circuits, such as antennas, amplifiers, filters, mixers, oscillators, digital signal processors (DSPs), and the like. The communication elements 26, 56, 64 may establish communication wirelessly by utilizing radio frequency (RF) signals and/or data that comply with communication standards such as cellular 2G, 3G, 4G or 5G, Institute of Electrical and Electronics Engineers (IEEE) 802.11 standard such as WiFi, IEEE 802.16 standard such as WiMAX, Bluetooth™, or combinations thereof. In addition, the communication elements 26, 56, 64 may utilize communication standards such as ANT, ANT+, Bluetooth™ low energy (BLE), the industrial, scientific, and medical (ISM) band at 2.4 gigahertz (GHz), or the like. Alternatively, or in addition, the communication elements 26, 56, 64 may establish communication through connectors or couplers that receive metal conductor wires or cables, like Cat 6 or coax cable, which are compatible with networking technologies such as ethernet. In certain embodiments, the communication elements 26, 56, 64 may also couple with optical fiber cables. The communication elements 26, 56, 64 may respectively be in communication with the processing elements 22, 52, 60 and/or the memory elements 24, 48, 62.

The memory elements 24, 48, 62 may include electronic hardware data storage components such as read-only memory (ROM), programmable ROM, erasable programmable ROM, random-access memory (RAM) such as static RAM (SRAM) or dynamic RAM (DRAM), cache memory, hard disks, floppy disks, optical disks, flash memory, thumb drives, universal serial bus (USB) drives, or the like, or combinations thereof. In some embodiments, the memory elements 24, 48, 62 may be embedded in, or packaged in the same package as, the processing elements 22, 52, 60. The memory elements 24, 48, 62 may include, or may constitute, a “computer-readable medium.” The memory elements 24, 48, 62 may store the instructions, code, code segments, software, firmware, programs, applications, apps, services, daemons, or the like that are executed by the processing elements 22, 52, 60. In an embodiment, the memory elements 24, 48, 62 respectively store the software applications/programs 28, 58, 66. The memory elements 24, 48, 62 may also store settings, data, documents, sound files, photographs, movies, images, databases, and the like.

The processing elements 22, 52, 60 may include electronic hardware components such as processors. The processing elements 22, 52, 60 may include digital processing unit(s). The processing elements 22, 52, 60 may include microprocessors (single-core and multi-core), microcontrollers, digital signal processors (DSPs), field-programmable gate arrays (FPGAs), analog and/or digital application-specific integrated circuits (ASICs), or the like, or combinations thereof. The processing elements 22, 52, 60 may generally execute, process, or run instructions, code, code segments, software, firmware, programs, applications, apps, processes, services, daemons, or the like. For instance, the processing elements 22, 52, 60 may respectively execute the software applications/programs 28, 58, 66. The processing elements 22, 52, 60 may also include hardware components such as finite-state machines, sequential and combinational logic, and other electronic circuits that can perform the functions necessary for the operation of embodiments of the current invention. The processing elements 22, 52, 60 may be in communication with the other electronic components through serial or parallel links that include universal busses, address busses, data busses, control lines, and the like.

Data sources hosted by the servers 14 may utilize a variety of formats and structures within the scope of the invention. For instance, relational databases and/or object-oriented databases may embody the data sources, and may be exposed for queries by one or more corresponding APIs. In one or more embodiments, analyses of account data stored by such a data source includes issuing a Structured Query Language (SQL) query to a database management system (DBMS) of such a data source to automatically determine delinquency label(s) for accountholders or accounts represented in the account data. One of ordinary skill will appreciate that—while examples presented herein may discuss specific types of operating systems and/or databases—a wide variety may be used alone or in combination within the scope of the present invention.

In one or more embodiments, training and labeling operations include the service device 16 performing automated computation of one or more velocity features for financial account data and/or credit accountholders. In one or more embodiments, the training and labeling operations include the service device 16 performing automated labeling processes, including based at least in part on or in conjunction with the one or more velocity features. In each case, the service device 16 may generate model training data based on the velocity features and/or automated delinquency labeling operations, and may train a machine learning model to determine credit risk based thereon, as discussed in more detail below.

The training and labeling operations of embodiments of the present invention, and the corresponding machine learning models whose training is enabled by such training data, may generally seek to improve machine recognition of patterns indicative of increased or decreased risk of delinquency in credit accounts or among credit accountholders.

It is foreseen that machine learning methods may be used to support learning by the program 66 and/or service device 16 in connection with determining credit risks for credit accountholders based on financial account data, demographic data, velocity feature(s) (collectively, input data) and/or automatically determined delinquency labels (training labels to teach expected outputs correlated with credit risk). The machine learning program(s) supporting the credit risk determination system may therefore recognize or determine correlations between input data and credit risk.

The machine learning techniques or programs may include curve fitting, regression model builders, convolutional or deep learning neural networks, combined deep learning, pattern recognition, or the like. Based upon this data analysis, the machine learning program(s) may learn method(s) for accurately determining credit risk with efficient and automated computations and labeling.

It should be noted that, in supervised machine learning, the labeling system may be provided with example inputs (i.e., input data) and their associated outputs (i.e., delinquency labels), and may seek to discover a general rule that maps inputs to outputs for improved credit risk determination. In unsupervised machine learning, the labeling system may be required to find its own structure in unlabeled example inputs.

The labeling system may utilize classification algorithms such as Bayesian classifiers and decision trees, sets of pre-determined rules, and/or other algorithms. More particularly, the labeling system may include machine learning models comprising one or more of LLMs, logistic regression, decision tree(s), random forest(s), support vector machine(s), XGBoost, Keras Neural Networks, or the like, without limitation.

One of ordinary skill will appreciate that example velocity features based on or incorporating historical account and transaction data, automated labeling processes, and corresponding learning based on the labeled data may provide a computationally efficient and high-accuracy technological solution. In various examples, however, manual review and/or oversight may be incorporated into one or more such operations to provide appropriate safeguards against discrimination, bias, or the like, in addition to model drift, overfitting, underfitting or the like.

Through hardware, software, firmware, or various combinations thereof, the processing elements 22, 52, 60 may—alone or in combination with other processing elements—be configured to perform the operations of embodiments of the present invention. Specific embodiments of the technology will now be described in connection with the attached drawing figures. The embodiments are intended to describe aspects of the invention in sufficient detail to enable those skilled in the art to practice the invention. Other embodiments can be utilized and changes can be made without departing from the scope of the present invention. The system may include additional, less, or alternate functionality and/or device(s), including those discussed elsewhere herein. The following detailed description is, therefore, not to be taken in a limiting sense. The scope of the present invention is defined only by the appended claims, along with the full scope of equivalents to which such claims are entitled, unless otherwise expressly stated and/or readily apparent to those skilled in the art from the description.

### Exemplary Computer-Implemented Method Supporting Determination of Credit Risk

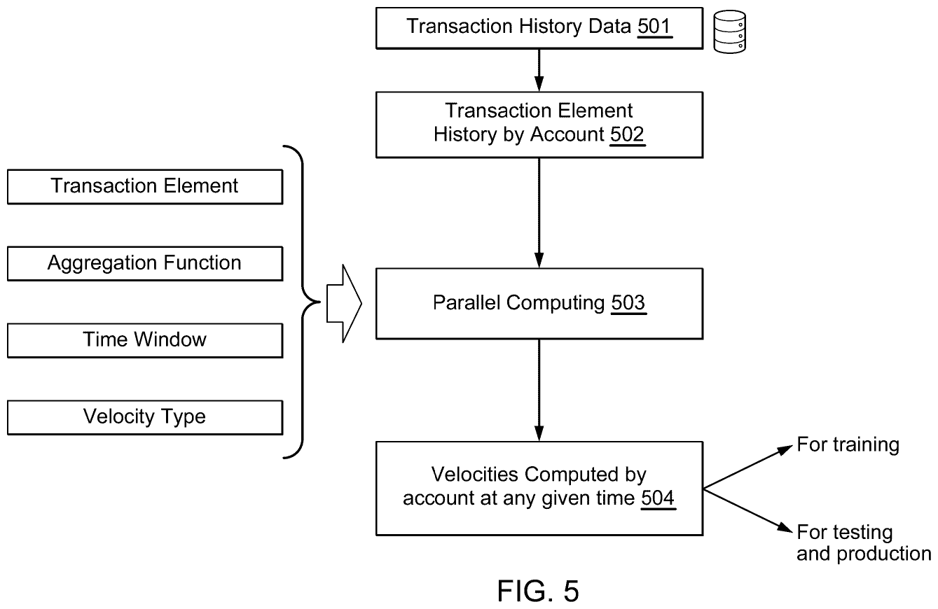

FIG. 5 illustrates a flowchart including a listing of operations of an exemplary computer-implemented method 500 for enabling credit risk determination through velocity feature generation. The operations may be performed in the order shown in FIG. 5, or they may be performed in a different order. Furthermore, some operations may be performed concurrently as opposed to sequentially. In addition, some operations may be optional.

The computer-implemented method 500 is described below, for ease of reference, as being executed by exemplary devices and components introduced with the embodiments illustrated in FIGS. 1-4. For example, the operations of the computer-implemented method 500 may be performed by the administrative devices 12, the servers 14, the service device 16 and the network 20 through the utilization of processors, transceivers, hardware, software, firmware, or combinations thereof. However, a person having ordinary skill will appreciate that responsibility for all or some of such actions may be distributed differently among such devices or other computing devices without departing from the spirit of the present invention. One or more computer-readable medium(s) may also be provided. The computer-readable medium(s) may include one or more executable programs stored thereon, wherein the program(s) instruct one or more processing elements to perform all or certain of the operations outlined herein. The program(s) stored on the computer-readable medium(s) may instruct the processing element(s) to perform additional, fewer, or alternative actions, including those discussed elsewhere herein.

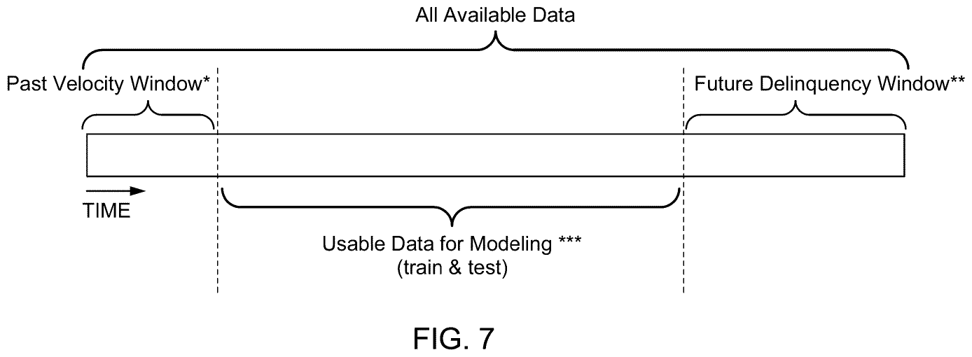

Initially, it should be noted that pre-processing may be performed on credit accountholder transaction history data, for example as described in more detail below in connection with FIG. 7. Moreover, feature engineering may be performed in connection with machine learning model construction.

Referring to operation 501, credit accountholder transaction history data may be obtained or identified, e.g., in the form of financial transaction records. In one or more embodiments, the command to obtain the data is executed by a program of a service device (e.g., service device 16 of FIG. 1 in a local environment), as discussed in more detail in preceding sections and/or otherwise in accordance with the discussion above.

Accordingly, it should be appreciated that related operations described above may also occur within the scope of the present invention. In one or more embodiments, the service device 16 requests financial transaction records spanning a pre-defined backward looking timeframe (e.g., the last three (3) years) for a group of credit accountholders known to have account opening dates (and, therefore, presumably available financial transaction records) for the timeframe. The transaction history data may be stored and provided by one or more servers 14, e.g., where a DBMS of a financial services company retrieves the records from the servers 14.

Referring to operation 502, the records may be parsed and/or data elements may be extracted therefrom on an account-by-account basis. In one or more embodiments, the parsing and/or extracting may be performed by the service device 16. For example, the program of the service device 16 may include instructions for recognizing predetermined data fields or elements (e.g., via labels or automated identification) in the transaction records for extraction for each account of the group of credit accountholders, and may store the extracted data elements by account for additional operations described in more detail below.

The data elements for each transaction represented in the transaction history data may include, for example: transaction amount in a specified currency (e.g., U.S. Dollars); merchant category; date of transaction; recurring transaction indicator; transaction or channel type; accountholder age; accountholder education level; accountholder income level; present balance; account credit limit; and other transaction data relevant to predicting account delinquency.

In various examples, the obtainment or identification of the transaction history data may include imposition of parameters in corresponding requests to filter or narrow the retrieved data. For example, where a server 14 implements an API for providing the transaction history data, the service device 16 request(s) to the server 14 may automatically establish or incorporate date range parameters for the retrieved transaction history data. Example data retrieval and/or parsing parameters are discussed in more detail below in connection with FIG. 7. It is foreseen that the retrieval parameters may entirely or partly obviate the need for parsing under operation 502, or vice versa, without departing from the spirit of the present examples.

Referring to operation 503, the elements from the transaction records may be fed to fast parallel computing operations for each account. For example, the program of the service device 16 may include instructions for calculating or otherwise preparing or retrieving values for variables needed to compute one or more velocities at operation 504, discussed in more detail below. The parsed and/or extracted data from operation 502 may be further parsed to identify the values for the variables, such as where dollar values having particular labels (e.g., “debit”) and transaction dates are identified.

The identified and/or pre-computed variable values may be identified and/or pre-computed based on the velocity sought at operation 504. For example, an aggregation function such as sum, max, min, average, median or the like may define one or more of the variables. For another example, a time window such as one (1) day, seven (7) days, thirty (30) days, ninety (90) days or the like may be defined for identification of relevant transaction dates. For yet another example, a velocity type, such as exponential decaying (e.g., more recent data is weighted more heavily than older data) or uniform velocity types may be used. Example velocities include average balance over a trailing three (3) month time window, maximum payment over a trailing six (6) month time window, and other velocities.

Referring to operation 504, the velocities may be computed for each account using the variable values. For example, the program of the service device 16 may include instructions for computing a velocity for each account for each month of a relevant inquiry period. A velocity may be a value for a statistical metric computed from a time series of historical events involving a corresponding one of the plurality of credit accountholders. For example, a velocity may be an average amount of spending or a maximum payment over a lookback window (e.g., over the preceding six (6) months) for the account. It will be appreciated by a person having ordinary skill that a variety of different statistical metrics computed from a time series are within the scope of the present invention.

A relevant inquiry period may be one (1) or more years or, possibly, a timeframe shorter than one (1) year. However, wherever the velocities are used to automatically generate delinquency training labels according to the method 600 discussed in more detail below, the relevant inquiry period may be bounded by pre-and post-buffer periods discussed in more detail below in connection with FIG. 7. Briefly, snapshots of each of the credit accountholder accounts may be prepared at two (2) moments in time (e.g., at the end of the first month or cycle and at the end of the twelfth month or cycle of a given year). Each of the two snapshots may rely on variable values and/or velocities computed from transactions that occurred on or after some early date occurring before the corresponding moment in time, and/or from transactions that occurred on or before some late date occurring after the corresponding moment in time. Where the corresponding account was not open or active before such an early date, or where such a late date is after a present moment (at which the computations are being performed), then usable data may not be available. In such cases, the inquiry period may be adjusted so that usable data can be obtained in view of pre-and post-buffer periods for each of the credit accountholder accounts.

In a more particular example, each time at which account data is compiled or computed for inclusion in training data sets may be a date, such as the last date of a month in the inquiry period. The compiled training, validation and testing account data—including velocity feature data computed pursuant to method 500, demographic data, and/or other account data—may be compiled with reference to each such date within the inquiry period. If the inquiry period—i.e., the span of time within which valid data is available to complete the required retrieval and computations, optionally as limited by additional constraints (e.g., where the operator specifies that only the preceding year, comprising twelve (12) month-end dates, should be included)—includes multiple dates, then data will be compiled for each such date. In various examples, the retrieval and computation of velocities for each such date may include data for the corresponding month, and optionally prior data, depending on the metric or computation at issue (e.g., average month spend over the preceding three (3) months considers data in the defined trailing time window).

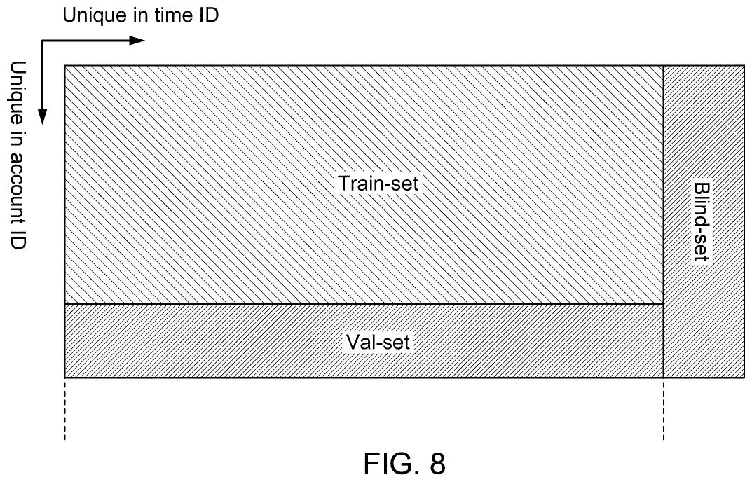

It should be noted that the velocities and variable values for each account at each relevant moment in time may be segmented by subgroups of the credit account holders and/or by subgroups according to time, for training and evaluation phases for a credit risk machine learning model, as discussed in more detail below in connection with FIG. 8.

The method may include additional, less, or alternate operations and/or device(s), including those discussed elsewhere herein, unless otherwise expressly stated and/or readily apparent to those skilled in the art from the description.

### Exemplary Computer-Implemented Method Supporting Determination of Credit Risk

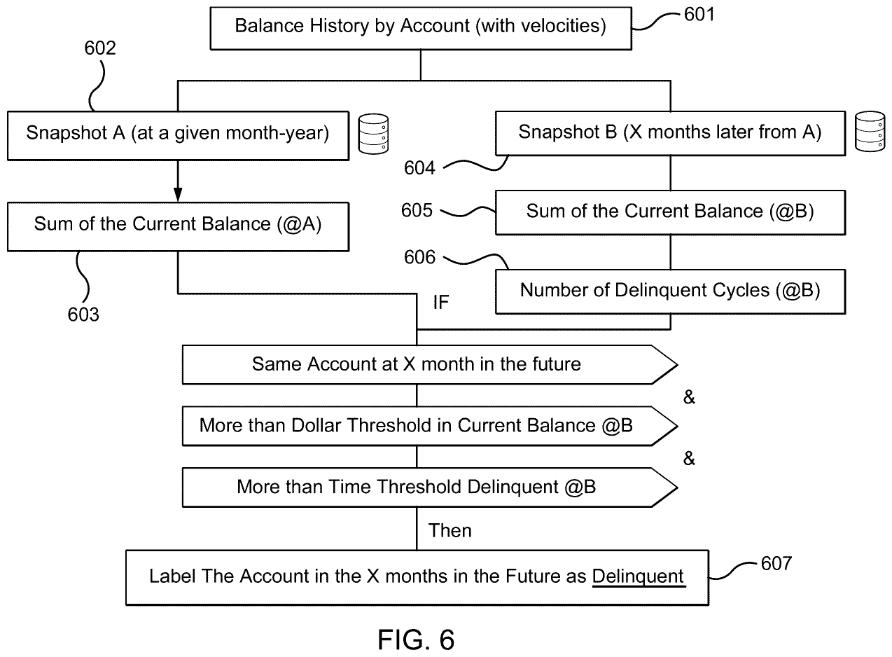

FIG. 6 illustrates a flowchart including a listing of operations of an exemplary computer-implemented method 600 for enabling credit risk determination through automated labeling of supervised model training data. The operations may be performed in the order shown in FIG. 6, or they may be performed in a different order. Furthermore, some operations may be performed concurrently as opposed to sequentially. In addition, some operations may be optional.

The computer-implemented method 600 is described below, for ease of reference, as being executed by exemplary devices and components introduced with the embodiments illustrated in FIGS. 1-4. For example, the operations of the computer-implemented method 600 may be performed by the administrative devices 12, the servers 14, the service device 16 and the network 20 through the utilization of processors, transceivers, hardware, software, firmware, or combinations thereof. However, a person having ordinary skill will appreciate that responsibility for all or some of such actions may be distributed differently among such devices or other computing devices without departing from the spirit of the present invention. One or more computer-readable medium(s) may also be provided. The computer-readable medium(s) may include one or more executable programs stored thereon, wherein the program(s) instruct one or more processing elements to perform all or certain of the operations outlined herein. The program(s) stored on the computer-readable medium(s) may instruct the processing element(s) to perform additional, fewer, or alternative actions, including those discussed elsewhere herein.

Referring to operation 601, credit accountholder transaction history data may be obtained, e.g., in the form of financial transaction records. In one or more embodiments, a command to obtain the data is executed by a program of a service device (e.g., service device 16 of FIG. 1 in a local environment), as discussed in more detail in preceding sections and/or otherwise in accordance with the discussion above. Accordingly, it should be appreciated that related operations described above may also occur within the scope of the present invention.

In one or more embodiments, the service device 16 requests financial transaction records spanning a pre-defined backward looking timeframe (e.g., the last three (3) years) for a group of credit accountholders known to have account opening dates (and, therefore, presumably available financial transaction records) for the timeframe. The transaction history data may be stored and provided by one or more servers 14, e.g., where a DBMS of a financial services company retrieves the records from the servers 14.

In one or more embodiments, operation 601 is preceded by one or more operations of the method 500 discussed in more detail above. Accordingly, operation 601 may include retrieving and/or identifying the variable values, velocities and other account data retrieved, obtained, identified and/or computed pursuant to the method 500 for each of the group of credit accountholders.

Referring to operation 602, a first snapshot or Snapshot A may be generated or identified for a first moment in time. For example, the program of the service device 16 may include instructions for gathering, identifying and/or computing a pre-determined array of values for one or more data elements and/or velocities comprising input vectors or other input to a machine learning model for credit risk prediction or estimation. The input vector may include the data elements and/or velocities describing the status of each of the accounts at the moment in time, as well as preceding and subsequent events, sums, and/or account trends (or velocities). The moment in time may be referred to as moment “A,” which precedes a second moment in time “B” discussed in more detail below. In an example, moment “A” may be the end of the first month or cycle of a given year (e.g., the inquiry period). The moment “B” may be the end of the twelfth month or cycle of the given year.

Referring to operation 603, a sum of the current balance at the first or A moment in time may be identified, retrieved or computed for each account of the credit accountholders of the group. For example, the program of the service device 16 may include instructions for identifying or retrieving the sum at the first or A moment in time from among data elements of preceding operations and/or for computing the sum from the transaction records or elements thereof.

Referring to operation 604, a second snapshot or Snapshot B may be generated for the second moment in time. For example, the program of the service device 16 may include instructions for gathering, identifying and/or computing a pre-determined array of values for one or more data elements and/or velocities comprising input vectors or other input to a machine learning model for credit risk prediction or estimation. The input vector may include the data elements and/or velocities describing the status of each of the accounts at the second moment in time, as well as preceding and subsequent events, sums, and/or account trends (or velocities). In the example introduced above, the moment “B” is the end of the twelfth month or cycle of the given year.

Referring to operation 605, a sum of the current balance at the second (B) moment in time may be identified, retrieved or computed for each account of the credit accountholders of the group. For example, the program of the service device 16 may include instructions for identifying or retrieving the sum at the second moment in time from among data elements of preceding operations and/or for computing the sum from the transaction records or elements thereof.

Referring to operation 606, a number of delinquent cycles at the second (B) moment in time may be identified, retrieved or computed for each account of the credit accountholders of the group. For example, the program of the service device 16 may include instructions for identifying or retrieving the number of delinquent cycles at the second moment in time from among the data elements of preceding operations and/or for computing same from the transaction records or elements thereof.

Referring to operation 607, a delinquency determination is made for each of the accounts at the second moment in time, and one or more corresponding delinquency labels are automatically applied to the input vectors or other machine learning input comprising the credit accountholder data. In one or more embodiments, the program of the service device 16 includes instructions for determining a delinquency status at the second moment in time and applying corresponding labels for each account or for a subgroup of accounts which are either delinquent or not delinquent. For example, a delinquency label may be applied indicating either delinquency or lack thereof, with the lack of a label implying the absence of the labeled condition. For another example, a delinquency label having a first value (e.g., “1”) may be applied to the input vector for each account having a first condition (e.g., delinquent) and a delinquency label having a second value (e.g., “0”) may be applied to the input vector for each account having a second condition (e.g., not delinquent).

In one or more embodiments, the delinquency determination is made based on delinquency criteria evaluated at the second moment in time. The program of the service device 16 may include instructions for applying the criteria to the variable values, velocities and other account data to make the delinquency determination. For example, if such values are available for the same account at the first and second moments in time, the current balance for the account at the second moment in time is more than a dollar threshold (e.g., one hundred dollars ($100 USD)), and the account has been delinquent for at least a threshold amount of time (e.g., two (2) months, meaning during the two (2) cycles immediately preceding or including the second moment in time, or during two (2) other cycles meeting other timing and/or contiguousness criteria), then the account may be considered “delinquent” and a corresponding label may be applied.

In one or more embodiments, one or more (and, possibly, all) of the operations of the methods 500 and/or 600 are automatically performed responsive to issuance of a Structured Query Language (SQL) code query to a database management system (DBMS) (e.g., of one or more of the servers 14) by the service device 16 for retrieval of the transaction records of the credit accountholders.

Advantageously, combining account velocities and automatically-generated delinquency labels permits automated machine learning for making credit risk determinations, as the velocities permit the machine learning model to evaluate trends and trajectories of account data in time adjacent a delinquency state and to correlate same to the delinquency state, thereby improving efficiency of a machine learning process without the heavy encumbrance of human labeling requirements.

Moreover, preferably the input vectors for each account are prepared with variable inquiry periods and variable gaps between the first and second moments in time, so that the machine learning model may learn, for example, which inquiry period(s) and gap(s) to weight or otherwise emphasize more heavily when making credit risk determinations. In one or more embodiments, the operations of method(s) 500 and/or 600 are repeated iteratively for each possible gap between first and second moments in an inquiry period (i.e., where each month is an integer such as first month (1), second month (2) etc., and all possible gaps within the group of integers are used to compute delinquency labels and input vectors for training). Such iterative learning across multiple accounts permits the machine learning model to learn correlations within a given account over time, and across accounts.

In one or more embodiments, the input vectors comprising variable values, velocities and/or other account data, along with delinquency labels, discussed in more detail in connection with one or both of methods 500 and 600 above, may be or be used to generate training data inputted to one or more machine learning models. The training data may include, for each of the credit accountholders, demographic data including age, education level and/or income level, as well as transaction amounts for corresponding transactions, balance amounts, and applicable credit limit.

The machine learning model(s) may be trained to correlate one or more aspects of the input vectors to the delinquency status at the second moment in time. The trained machine learning model(s) may be implemented or deployed to production environments—such as those of one or more financial institutions—for use in predicting whether a given credit accountholder or potential credit accountholder will enter a delinquent status at one or more future moments in time.

The method may include additional, less, or alternate operations and/or device(s), including those discussed elsewhere herein, unless otherwise expressly stated and/or readily apparent to those skilled in the art from the description.

### Exemplary Computer-Implemented Methods for Data Selection Supporting Determination of Credit Risk

FIGS. 7-8 illustrate logical delineations of data based on time and account identification, which may be implemented via operations performed in the order discussed below or in a different order. Furthermore, some operations may be performed concurrently as opposed to sequentially. In addition, some operations may be optional.

The operations corresponding to FIGS. 7-8 are described below, for ease of reference, as being executed by exemplary devices and components introduced with the embodiments illustrated in FIGS. 1-4. For example, the operations may be performed by the administrative devices 12, the servers 14, the service device 16 and the network 20 through the utilization of processors, transceivers, hardware, software, firmware, or combinations thereof. However, a person having ordinary skill will appreciate that responsibility for all or some of such actions may be distributed differently among such devices or other computing devices without departing from the spirit of the present invention. One or more computer-readable medium(s) may also be provided. The computer-readable medium(s) may include one or more executable programs stored thereon, wherein the program(s) instruct one or more processing elements to perform all or certain of the operations outlined herein. The program(s) stored on the computer-readable medium(s) may instruct the processing element(s) to perform additional, fewer, or alternative actions, including those discussed elsewhere herein.

Turning specifically to FIG. 7, usable data is delineated in a central region of the illustrated time scale. The inquiry period discussed in more detail above may fit within and define the usable data window. For example, where the inquiry period is one (1) year long and comprises twelve (12) moments in time (e.g., the last date of each month in the period), and data retrieved or computed for each moment in time has a maximum trailing window of three (3) months (where the data element or velocity that relies on the oldest data corresponds to the maximum trailing window), then the usable data region comprises fifteen (15) months. The illustrated past velocity window accordingly does not contain usable data because the required data is not available. Similarly, the illustrated future delinquency window corresponds to dates on which delinquency labels cannot be generated. As discussed above, this delineation of usable data may be performed in connection with retrieving, parsing, and/or computing/compiling data in connection with methods 500, 600 within the scope of the present examples.

Turning now to FIG. 8, usable data may be further segmented into training, validation and blind sets. The training set may be passed as input (e.g., input vectors) to the machine learning model for training, to include adjustment of internal model variables or parameters (e.g., model weights and biases) according to an optimization function. The validation set may be used to adjust hyperparameters of the model, such as learning rate, number of neural network layers, regularization strength, or other external configurations which may be selected by an operator to correct overfitting and/or underfitting. The blind set may be used, after training and validation, to test the trained and validated machine learning model to determine quality and efficiency of performance. As illustrated in FIG. 8, the blind set may be delineated from the body of usable data according to time (e.g., where newest data is segregated from the remaining usable data and reserved for testing). The validation set may, in turn, be delineated from the body of usable data according to accountholder/account (e.g., where a subset of all accounts represented in the usable data are separated out from training and testing sets and reserved for validation operations).

The method(s) for data selection may include additional, less, or alternate operations and/or device(s), including those discussed elsewhere herein, unless otherwise expressly stated and/or readily apparent to those skilled in the art from the description.

### Additional Considerations

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current technology can include a variety of combinations and/or integrations of the embodiments described herein.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein, unless otherwise expressly stated and/or readily apparent to those skilled in the art from the description.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as a processing element, may be implemented as special purpose or as general purpose. For example, the processing element may comprise dedicated circuitry or logic that is permanently configured, such as an application-specific integrated circuit (ASIC), or indefinitely configured, such as an FPGA, to perform certain operations. The processing element may also comprise programmable logic or circuitry (e.g., as encompassed within a general-purpose processor or other programmable processor) that is temporarily configured by software to perform certain operations. It will be appreciated that the decision to implement the processing element as special purpose, in dedicated and permanently configured circuitry, or as general purpose (e.g., configured by software) may be driven by cost and time considerations.

Accordingly, the term “processing element” or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processing element is temporarily configured (e.g., programmed), each of the processing elements need not be configured or instantiated at any one instance in time. For example, where the processing element comprises a general-purpose processor configured using software, the general-purpose processor may be configured as respective different processing elements at different times. Software may accordingly configure the processing element to constitute a particular hardware configuration at one instance of time and to constitute a different hardware configuration at a different instance of time.

Computer hardware components, such as communication elements, memory elements, processing elements, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, at a later time, access the memory device to retrieve and process the stored output. Computer hardware components may also initiate communications with input or output devices, and may operate on a resource (e.g., a collection of information).

The various operations of example methods described herein may be performed, at least partially, by one or more processing elements that are temporarily configured (e.g., by software) or permanently configured to perform the relevant operations. Whether temporarily or permanently configured, such processing elements may constitute processing element-implemented modules that operate to perform one or more operations or functions. The modules referred to herein may, in some example embodiments, comprise processing element-implemented modules.

Similarly, the methods or routines described herein may be at least partially processing element-implemented. For example, at least some of the operations of a method may be performed by one or more processing elements or processing element-implemented hardware modules. The performance of certain of the operations may be distributed among the one or more processing elements, not only residing within a single machine, but deployed across a number of machines. In some example embodiments, the processing elements may be located in a single location (e.g., within a home environment, an office environment or as a server farm), while in other embodiments the processing elements may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processing element and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

The patent claims at the end of this patent application are not intended to be construed under 35 U.S.C. § 112(f) unless traditional means-plus-function language is expressly recited, such as “means for” or “step for” language being explicitly recited in the claim(s).

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

We claim:

1. Non-transitory computer-readable storage media having computer-executable instructions stored thereon for automated determination of credit risk, wherein when executed by at least one processor the computer-executable instructions cause the at least one processor to:
retrieve first account data of a plurality of credit accountholders, the first account data originating at or prior to a first time;
analyze second account data of the plurality of credit accountholders to determine a delinquency label for each of the plurality of credit accountholders at a second time, the second account data originating at or prior to the second time and the second time being after the first time;
generate model training data based on the first account data, the second account data, and the plurality of delinquency labels corresponding to the plurality of credit accountholders;
train a machine learning model to predict future delinquency status using supervised learning with the model training data as input; and
deploy the trained machine learning model for use in a production environment.

2. The non-transitory computer-readable storage media of claim 1, wherein the second time is a number of months after the first time, the number of months being selected from a group consisting of integers between one (1) and twelve (12), inclusive, and wherein generating the model training data includes—
repeating the retrieval and analysis steps iteratively for remaining ones of the integers of the group of integers, such that twelve (12) sets of the first account data and twelve sets of the second account data and of the corresponding delinquency labels are included in the model training data.

3. The non-transitory computer-readable storage media of claim 1, wherein the determination of the delinquency label for each of the plurality of credit accountholders at the second time is made based on criteria including a balance and a number of delinquent cycles as of the second time.

4. The non-transitory computer-readable storage media of claim 3, wherein the criteria require a balance of at least one hundred dollars U.S. ($100 USD) and more than two (2) months of delinquent cycles for a corresponding one of the plurality of credit accountholders to receive a delinquent value for the corresponding delinquency label.

5. The non-transitory computer-readable storage media of claim 1, wherein the first account data, the second account data and the model training data each include, for each of the plurality of credit accountholders, at least one of a plurality of velocity features, the plurality of velocity features each comprising a value for a statistical metric computed from a time series of historical events involving a corresponding one of the plurality of credit accountholders.

6. The non-transitory computer-readable storage media of claim 5, wherein the plurality of velocity features includes one or both of an average amount of spending or a maximum payment, in each case by the corresponding one of the plurality of credit accountholders over a lookback window extending a number of months before a corresponding one of the first time or the second time.

7. The non-transitory computer-readable storage media of claim 5, wherein the first account data, the second account data and the model training data each include, for each of the plurality of credit accountholders, demographic data including age, education level, and income level.

8. The non-transitory computer-readable storage media of claim 5, wherein one or more of the plurality of velocity features are computed using an exponential decay function.

9. The non-transitory computer-readable storage media of claim 1, wherein the analysis of the second account data to determine the delinquency label for each of the plurality of credit accountholders at the second time is automatically performed responsive to issuance of a Structured Query Language (SQL) code query to a database management system (DBMS).

10. The non-transitory computer-readable storage media of claim 1, the generation of the model training data including—
tagging and removing a blind set of data based on recency of corresponding portions of the first account data and the second account data; and
tagging and removing a validation set of data based on identity of the plurality of credit accountholders.

11. A computer-implemented method for automated determination of credit risk, comprising, via one or more transceivers and/or processors:
retrieving first account data of a plurality of credit accountholders, the first account data originating at or prior to a first time;
analyzing second account data of the plurality of credit accountholders to determine a delinquency label for each of the plurality of credit accountholders at a second time, the second account data originating at or prior to the second time and the second time being after the first time;
generating model training data based on the first account data, the second account data and the plurality of delinquency labels corresponding to the plurality of credit accountholders;
training a machine learning model to predict future delinquency status using supervised learning with the model training data as input; and
deploying the trained machine learning model for use in a production environment by a financial institution in predicting the future delinquency status of one or more credit accounts.

12. The computer-implemented method of claim 11, wherein the second time is a number of months after the first time, the number of months being selected from a group consisting of integers between one (1) and twelve (12), inclusive, and wherein generating of the model training data includes—
repeating the retrieval and analysis steps iteratively for remaining ones of the integers of the group of integers, such that twelve (12) sets of the first account data and twelve sets of the second account data and of the corresponding delinquency labels are included in the model training data.

13. The computer-implemented method of claim 11, wherein the determination of the delinquency label for each of the plurality of credit accountholders at the second time is made based on criteria including a balance and a number of delinquent cycles as of the second time.

14. The computer-implemented method of claim 13, wherein the criteria require a balance of at least one hundred dollars U.S. ($100 USD) and more than two (2) months of delinquent cycles for a corresponding one of the plurality of credit accountholders to receive a delinquent value for the corresponding delinquency label.

15. The computer-implemented method of claim 11, wherein the first account data, the second account data and the model training data each include, for each of the plurality of credit accountholders, at least one of a plurality of velocity features, the plurality of velocity features each comprising a value for a statistical metric computed from a time series of historical events involving a corresponding one of the plurality of credit accountholders.

16. The computer-implemented method of claim 15, wherein the plurality of velocity features includes one or both of an average amount of spending or a maximum payment by the corresponding one of the plurality of credit accountholders over a lookback window extending a number of months before a corresponding one of the first time or the second time.

17. The computer-implemented method of claim 16, wherein the lookback window is three (3) or six (6) months.

18. The computer-implemented method of claim 15, wherein the first account data, the second account data and the model training data each include, for each of the plurality of credit accountholders, demographic data including age, education level, and income level.

19. The computer-implemented method of claim 15, wherein one or more of the plurality of velocity features are computed using an exponential decay function.

20. The computer-implemented method of claim 11, the generation of the model training data including—
tagging and removing a blind set of data based on recency of corresponding portions of the first account data and the second account data; and
tagging and removing a validation set of data based on identity of the plurality of credit accountholders.
